(19) United States
(12) Patent Application Publication
(10) Pub. No.: US 2023/0326316 A1
(43) Pub. Date: Oct. 12, 2023

(54) SYSTEM AND METHOD FOR ESTIMATING LOCATION OF FOREST FIRE

(71) Applicant: AlcheraX, Inc., Sunnyvale, CA (US)

(72) Inventors: Hee Chan PARK, Ansan-si (KR); Minkook CHO, Seoul (KR); Yoon Jin CHOI, Seongnam-si (KR); Jae Hyeok KANG, Seongnam-si (KR); Robert Kenneth William Grey, Busan (KR)

(21) Appl. No.: 18/086,800

(22) Filed: Dec. 22, 2022

(30) Foreign Application Priority Data
Apr. 11, 2022 (KR) 10-2022-0044745
Sep. 26, 2022 (KR) 10-2022-0121931

(51) Int. Cl. G08B 17/12; G06V 20/52; G06V 20/00

(52) U.S. Cl. CPC G08B 17/125; G06V 20/38; G06V 20/52

(57) ABSTRACT

Provided are a system and method for estimating a location of a forest fire. The system for estimating the location of the forest fire may include an artificial intelligence-based forest fire detection module that detects a forest fire from a captured image using an artificial intelligence model; a monitoring camera configured to monitor a predetermined area; a direction estimation module configured to estimate a direction of the forest fire on a map, using a forest fire detection image provided from the artificial intelligence-based forest fire detection module and data of the monitoring camera; and a location estimation module configured to estimate the location of the forest fire, using an altitude map table configured to provide altitude of a corresponding location from latitude and longitude of the monitoring camera, based on the estimated direction of the forest fire.

### CROSS-REFERENCE TO RELATED APPLICATION

This application claims priority to and the benefit of Korean Patent Application No. 10-2022-0044745 filed in the Korean Intellectual Property Office on Apr. 11, 2022, and Korean Patent Application No. 10-2022-0121931 filed in the Korean Intellectual Property Office on Sep. 26, 2022, the entire contents of which are incorporated herein by reference.

### BACKGROUND

### (a) Technical Field

The disclosure relates to a system and method for estimating a location of a forest fire.

### (b) Description of the Related Art

Since forest fires occur in forests, the forest fires are difficult to be early detected and cause large-scale damage when the forest fires spread. That is, the earlier the initial detection and the more accurately the location of a forest fire is identified, the easier it is to extinguish the forest fire and the more likely it is to prevent the spread in advance. To this end, various methods of fire detection are being researched, such as using an Internet of Things (IoT) sensor, using a satellite image analysis, or detecting a fire based on a camera. In addition, when a fire is detected, research on technology of estimating a location where the fire has occurred and providing a forest fire notification to users is also active.

### SUMMARY

The present disclosure has been made in an effort to provide a system and method for estimating a location of a forest fire having advantages of estimating the location of the forest fire.

Another embodiment of the present disclosure provides a system for estimating the location of the forest fire including an artificial intelligence-based forest fire detection module that detects a forest fire from a captured image using an artificial intelligence model; a monitoring camera configured to monitor a predetermined area; a direction estimation module configured to estimate a direction of the forest fire on a map, using a forest fire detection image provided from the artificial intelligence-based forest fire detection module and data of the monitoring camera; and a location estimation module configured to estimate the location of the forest fire, using an altitude map table configured to provide altitude of a corresponding location from latitude and longitude of the monitoring camera, based on the estimated direction of the forest fire.

In some embodiments, the direction estimation module may output the direction of the forest fire on the map using a horizontal angle and a vertical angle.

In some embodiments, the location estimation module may specify the direction of the forest fire using the horizontal angle obtained through the direction estimation module.

In some embodiments, the location estimation module may specify the direction of the forest fire by defining a straight line between the monitoring camera and a ground using the vertical angle obtained through the direction estimation module, and finding a point where the defined straight line crosses the altitude.

In some embodiments, the forest fire detection image may include an image generation time, an image resolution value, and pixel information where the forest fire is located.

In some embodiments, the data of the monitoring camera may include information about a camera field of view (FoV), a camera position including a latitude and a longitude, and a camera pan-tilt-zoom (PTZ).

In some embodiments, the direction estimation module may estimate the direction of the forest fire on the map based on the pixel information and the information about the camera FoV and the camera PTZ.

In some embodiments, when the data of the monitoring camera is provided at a first time and a second time, and the forest fire detection image is provided between the first time and the second time, the direction estimation module may estimate the direction of the forest fire on the map based on the data at the first time if the data at the first time is the same as the data at the second time, and estimate the direction of the forest fire on the map based on the data at the first time if the data at the first time is different from the data at the second time, and if values of a pan and a FoV of the second time are included in values of a pan and a FoV at the first time.

Yet another embodiment of the present disclosure provides a method of estimating a location of a forest fire including detecting the forest fire from a captured image using an artificial intelligence model; monitoring a predetermined area, using a monitoring camera; estimating a direction of the forest fire on a map, using a detected forest fire detection image and data of the monitoring camera; and estimating the location of the forest fire, using an altitude map table configured to provide altitude of a corresponding location from latitude and longitude of the monitoring camera, based on the estimated direction of the forest fire.

In some embodiments, the estimating of the direction of the forest fire may include outputting the direction of the forest fire on the map using a horizontal angle and a vertical angle.

In some embodiments, the estimating of the direction of the forest fire may include specifying the direction of the forest fire using the horizontal angle.

In some embodiments, the estimating of the direction of the forest fire may include estimating the direction of the forest fire by defining a straight line between the monitoring camera and a ground using the vertical angle, and finding a point where the defined straight line crosses the altitude.

In some embodiments, the forest fire detection image may include an image generation time, an image resolution value, and pixel information where the forest fire is located.

In some embodiments, the data of the monitoring camera may include information about a camera field of view (FoV), a camera position including a latitude and a longitude, and a camera pan-tilt-zoom (PTZ).

In some embodiments, the estimating of the direction of the forest fire on the map may include estimating the direction of the forest fire on the map based on the pixel information and the information about the camera FoV and the camera PTZ.

In some embodiments, when the data of the monitoring camera is provided at a first time and a second time, and the forest fire detection images are provided between the first time and the second time, the estimating of the direction of the forest fire on the map may include estimating the direction of the forest fire on the map based on the data at the first time if the data at the first time is the same as the data at the second time, and estimating the direction of the forest fire on the map based on the data at the first time if the data at the first time is different from the data at the second time, and if values of a pan and a FoV of the second time are included in values of a pan and a FoV at the first time.

### BRIEF DESCRIPTION OF THE DRAWINGS

FIG. 1 is a block diagram illustrating a system for estimating a location of a forest fire according to an embodiment.

FIG. 2 is a block diagram illustrating a system for estimating a location of a forest fire according to an embodiment.

FIG. 3 is a flowchart illustrating a method of estimating a location of a forest fire according to an embodiment.

FIGS. 4 to 8 are diagrams illustrating an operation of a system for estimating a location of a forest fire according to an embodiment.

FIG. 9 is a diagram illustrating an operation of a system for estimating a location of a forest fire according to an embodiment.

FIGS. 10 and 11 are diagrams illustrating forest fire detection images including an estimated location of a forest fire according to an embodiment.

FIG. 12 is a block diagram illustrating a computing device for implementing a system and method for estimating a location of a forest fire according to embodiments.

### DETAILED DESCRIPTION OF THE EMBODIMENTS

Hereinafter, with reference to the accompanying drawings, the present disclosure will be described in detail such that those skilled in the art may easily carry out the present disclosure with respect to the embodiments of the present disclosure. However, the present disclosure may be embodied in many different forms and is not limited to the embodiments set forth herein. In addition, to clearly describe the present disclosure, parts unrelated to the descriptions are omitted, and the same or similar elements are denoted with the same reference numerals throughout the specification.

Throughout the specification, unless explicitly described to the contrary, the word “comprise”, and variations such as “comprises” or “comprising”, will be understood to imply the inclusion of stated elements but not the exclusion of any other elements.

In addition, the terms “-er”, “-or”, and “module” described in the specification mean units for processing at least one function and operation, and may be implemented by hardware components or software components, and combinations thereof. In addition, a prediction method capable of correcting a renewable energy error using a battery according to the embodiments described below may be implemented as a program or software, and the program or software may be stored in a computer-readable medium.

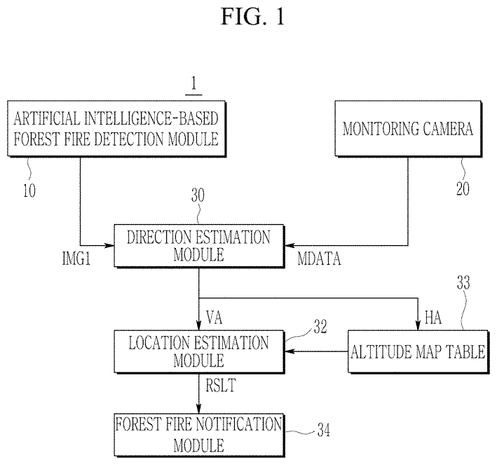

FIG. 1 is a block diagram illustrating a system for estimating a location of a forest fire according to an embodiment.

Referring to FIG. 1, a system 1 for estimating a location of a forest fire according to an embodiment may include an artificial intelligence-based forest fire detection module 10, a monitoring camera 20, a direction estimation module 30, a location estimation module 32, an altitude map table 33, and a forest fire notification module 34.

The artificial intelligence-based forest fire detection module 10 may detect a forest fire from a captured image using an artificial intelligence model. Specifically, the artificial intelligence-based forest fire detection module 10 may receive captured images from a camera installed for fire monitoring, analyze the captured images through the artificial intelligence model, and determine whether a fire actually has occurred from anomalies such as a smoke generation in the captured images. In some embodiments, the artificial intelligence-based forest fire detection module 10 may detect the forest fire using a deep learning technique.

The monitoring camera 20 may monitor a predetermined area where the forest fire is likely to occur. The monitoring camera 20 may capture the predetermined area where the forest fire is likely to occur at a predetermined time interval and provide a captured image such as a color image, a near-infrared image, etc.

The direction estimation module 30 may estimate a direction of the forest fire on a map, using a forest fire detection image IMG1 provided from the artificial intelligence-based forest fire detection module 10 and data MDATA of the monitoring camera 20. Specifically, the direction estimation module 30 may output the direction of the forest fire on the map, using a horizontal angle HA and a vertical angle VA. Here, the horizontal angle HA and the vertical angle VA may indicate in which direction the forest fire on the forest fire detection image IMG1 has actually occurred from the monitoring camera 20 on an actual map.

The forest fire detection image IMG1 may include an image generation time, an image resolution value, and pixel information where the forest fire is located. Here, the pixel information where the forest fire is located may include pixel information about a bounding box displayed to surround smoke or flame that is predicted to be the forest fire. The bounding box may be generated by the above-described artificial intelligence model.

The data MDATA of the monitoring camera 20 may include information about a camera field of view (FoV), a camera position including latitude and longitude, and a camera pan-tilt-zoom (PTZ).

The direction estimation module 30 may estimate the direction of the forest fire on the map, using the pixel information where the forest fire is located, and the information about the camera FoV and the camera PTZ. Here, the direction of the forest fire may be expressed in the horizontal angle HA. Although only the horizontal angle HA was used to estimate the direction of the forest fire on the map, it is also necessary to use the vertical angle VA to estimate the location of the forest fire.

The location estimation module 32 may estimate the location of the forest fire by specifying the direction of the forest fire using the horizontal angle HA obtained through the direction estimation module 30, obtaining altitude with respect to the direction of the forest fire from the altitude map table 33, defining a straight line between the monitoring camera 20 and a ground using the vertical angle VA obtained through the direction estimation module 30, and finding a point where the corresponding straight line crosses altitudes. Here, the altitude map table 33 may receive the latitude and longitude of the camera, and may obtain the altitude of a location corresponding to the latitude and longitude.

The forest fire notification module 34 may provide a forest fire notification to a user based on a determination result RSLT derived from the location estimation module 32. Accordingly, when a fire is detected, the location of the fire is estimated and provided to a user along with the forest fire notification, so that the user may quickly and accurately identify the location of the forest fire.

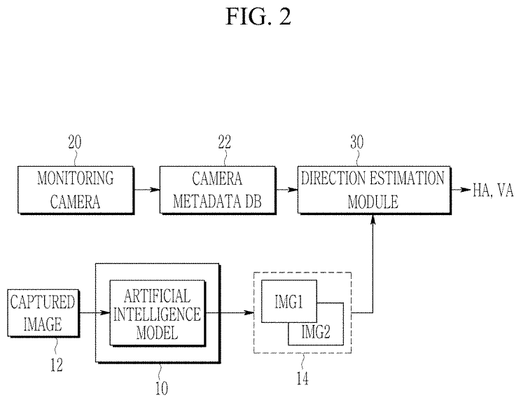

FIG. 2 is a block diagram illustrating a system for estimating a location of a forest fire according to an embodiment.

Referring to FIG. 2, in the system for estimating the location of the forest fire according to an embodiment, the data MDATA of a monitoring camera may be stored in a camera metadata database (DB) 22. In addition, the direction estimation module 30 may read the data MDATA of the monitoring camera stored in the camera metadata DB 22 at a predetermined time period.

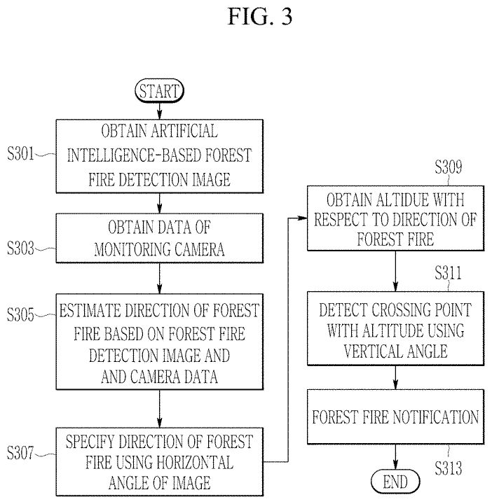

FIG. 3 is a flowchart illustrating a method of estimating a location of a forest fire according to an embodiment.

Referring to FIG. 3, in the method of estimating the location of the forest fire according to an embodiment, an artificial intelligence-based forest fire detection image may be obtained in step S301, and monitoring camera data may be obtained in step S303. In addition, the method may estimate a direction of the forest fire based on the forest fire detection image and camera data in step S305, and specify the direction of the forest fire using a horizontal angle of the forest fire detection image in step S307.

Next, the method may obtain altitude from the altitude map table 33 using latitude and longitude of the monitoring camera in step S309, and detect a crossing point with the altitude using a vertical angle of the forest fire detection image in step S311. In addition, the method may provide a user with the estimated location of the forest fire together with a forest fire notification in step S313.

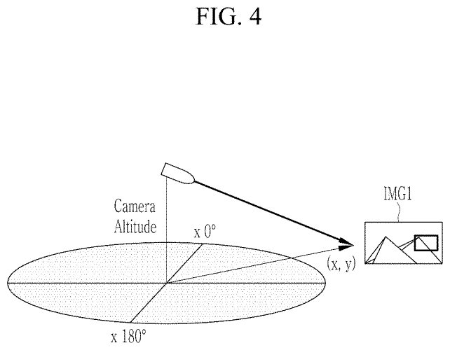

FIGS. 4 to 8 are diagrams illustrating an operation of a system for estimating a location of a forest fire according to an embodiment.

Referring to FIG. 4, in the system for estimating the location of the forest fire according to an embodiment, the direction estimation module 30 may output the horizontal angle HA and the vertical angle VA of the forest fire detection image IMG1 by using a spherical coordinate system. Specifically, the horizontal angle HA and the vertical angle VA of the forest fire detection image IMG1 may be expressed by x and y, respectively.

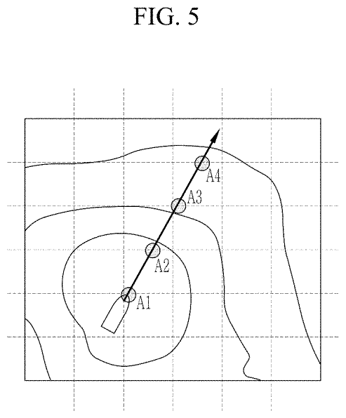

FIG. 5 shows that the location estimation module 32 specifies a direction of the forest fire using the horizontal angle HA obtained through the direction estimation module 30. Here, when an arrow extending in a direction of the horizontal angle HA from the monitoring camera 20 is defined, the arrow may extend to pass through points A1, A2, A3, and A4.

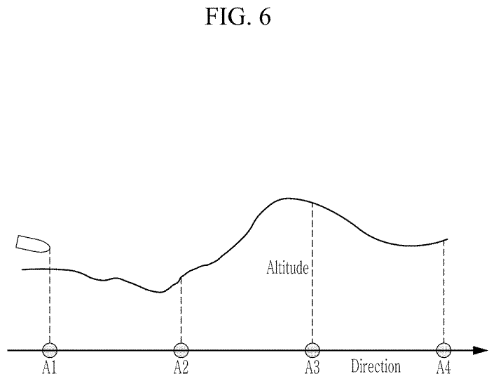

FIG. 6 shows a cross-section taken vertically from the ground along the arrow extending in the direction of the horizontal angle HA from the monitoring camera 20. Altitude of the corresponding coordinate may be known from the latitude and longitude of the monitoring camera 20, and as coordinates are continuously provided along the derived direction of the forest fire, a terrain may be estimated by analyzing the altitude according to the corresponding direction of the forest fire.

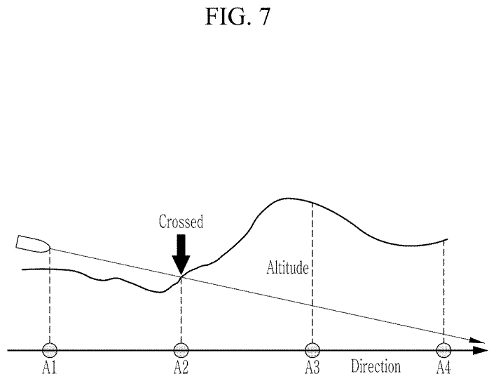

Referring to FIG. 7, the location of the forest fire may be estimated by defining a straight line between the monitoring camera 20 and the ground using the vertical angle VA obtained through the direction estimation module 30, and then, finding a point (“Crossed”) at which the corresponding straight line crosses altitudes.

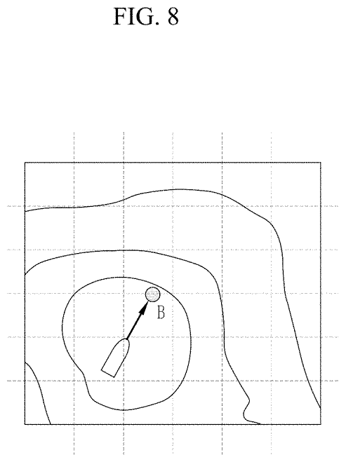

FIG. 8 shows an estimated location B of the forest fire converted into coordinates, and the forest fire notification module 34 may provide a user with a forest fire notification based on the determination result RSLT derived from the location estimation module 32. Accordingly, when a fire is detected, the location of the fire is estimated and provided to the user along with the forest fire notification, so that the user may quickly and accurately identify the location of the forest fire.

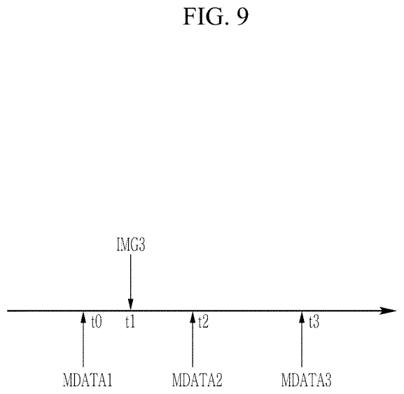

FIG. 9 is a diagram illustrating an operation of a system for estimating a location of a forest fire according to an embodiment.

Referring to FIG. 9, when data MDATA1 and MDATA2 of a monitoring camera are provided at a first time t0 and a second time t2, and a forest fire detection image IMG3 is provided at a third time t1 between the first time t0 and the second time t2, the direction estimation module 30 may estimate a direction of the forest fire on a map with respect to data at the first time t0 when the data at the first time t0 and data at the second time t2 are the same. Otherwise, when the data at the first time t0 and the data at the second time t2 are different from each other, and when values of a pan and an angle of view FoV at the second time t2 are included in values of a pan and an angle of view FoV at the first time t0, this may be determined as a zoom-in situation, and the direction of the forest fire on the map may be estimated with respect to the data at the first time to.

Here, the third time t1 may be obtained through a generation time of the forest fire detection image IMG3 included in Exchangable Image File format (Exif) information of the forest fire detection image IMG3, and the first time t0, the second time t2, and a fourth time t3 may be update times of the camera data MDATA1, MDATA2, and MDATA3.

An update period of the camera data MDATA1, MDATA2, and MDATA3 may be different from an update period of the forest fire detection image IMG3. For example, the update period of the camera data MDATA1, MDATA2, and MDATA3 may be 9 to 16 seconds, and the update period of the forest fire detection image IMG3 may be 10 seconds. Due to this, a direction estimation error may occur. According to the present embodiment, it is possible to prevent occurrence of such an error.

That is, when the camera data MDATA1 at the first time t0 is the same as the camera data MDATA2 at the second time t2, the direction estimation module may estimate the direction with respect to the values of the pan, zoom, and FoV at the first time t0.

When the camera data MDATA1 at the first time t0 is different from the camera data MDATA2 at the second time t2, if the values of the pan and the FoV at the second time t2 are included in the values of the pan and FoV at the first time t0, the direction estimation module 30 may determine this as the zoom-in situation, and estimate the direction with respect to the camera data MDATA1 at the first time t0.

When the camera data MDATA1 at the first time t0 is different from the camera data MDATA2 at the second time t2 but if the values of the pan and the FoV at the second time t2 are not included in the values of the pan and FoV at the first time t0, the direction estimation module 30 may recursively perform the method on the camera data MDATA2 at the second time t2 and the camera data MDATA3 at the fourth time t3. That is, when the camera data MDATA2 at the second time t2 is the same as the camera data MDATA3 at the fourth time t3, the direction estimation module 30 may estimate the direction with respect to the values of the pan, zoom, and FoV at the second time t2, when the camera data MDATA1 at the second time t2 is different from the camera data MDATA3 at the fourth time t3, if values of pan and the FoV at the fourth time t3 are included in the values of the pan and FoV at the second time t2, the direction estimation module 30 may determine this as the zoom-in situation, and estimate the direction with respect to the camera data MDATA2 at the second time t2.

According to the present embodiment, even when the update period of the camera data MDATA1, MDATA2, and MDATA3 is different from the update period of the forest fire detection image IMG3, it is possible to prevent the occurrence of a direction tracking error.

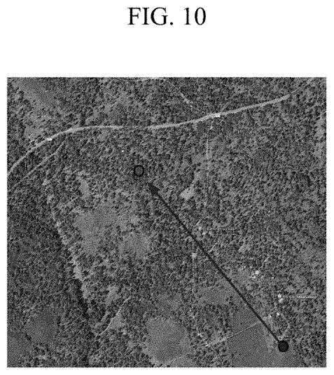

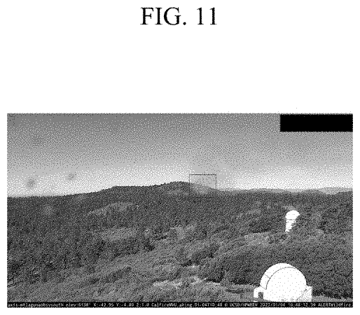

FIGS. 10 and 11 are diagrams illustrating forest fire detection images including an estimated location of a forest fire according to an embodiment.

Referring to FIG. 10, a first point marked with a circle at the lower right indicates a position of the monitoring camera, and a second point marked with a circle at the upper left with respect to the first point indicates an estimated location of the forest fire output by the location estimation module 32. In addition, an arrow from the first point to the second point indicates the direction of the forest fire. Here, the latitude and longitude of the monitoring camera may be 32.839649, −116.426521, and the latitude and longitude of the estimated location of the forest fire may be 32.89508 and −116.48096. FIG. 11 shows an example real image obtained by capturing the estimated location of the forest fire of FIG. 10.

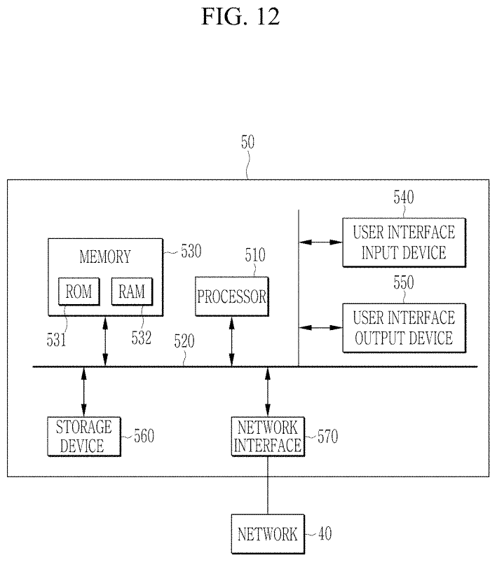

FIG. 12 is a block diagram illustrating a computing device for implementing a system and method for estimating a location of a forest fire according to embodiments.

Referring to FIG. 12, the system and method for estimating the location of the forest fire according to embodiments may be implemented using a computing device 50.

The computing device 50 may include at least one of a processor 510, a memory 530, a user interface input device 540, a user interface output device 550, and a storage device 560 that perform communication via a bus 520. The computing device 50 may also include a network interface 570 electrically connected to a network 40, for example, a wireless network. The network interface 570 may transmit or receive signals with other entities over the network 40.

The processor 510 may be implemented in various types such as an application processor (AP), a central processing unit (CPU), a graphics processing unit (GPU), etc., and may be any semiconductor device that executes a command stored in the memory 530 or the storage device 560. The processor 510 may be configured to implement the functions and methods described with respect to FIGS. 1 to 11.

The memory 530 and the storage device 560 may include various types of volatile or non-volatile storage media. For example, the memory 530 may include a read-only memory (ROM) 531 and a random access memory (RAM) 532. The memory 530 may be located inside or outside the processor 510, and the memory 530 may be connected to the processor 510 through various already known means.

In addition, at least part of the system and method for estimating the location of the forest fire according to the embodiments may be implemented as a program or software executed in the computing device 50, and the program or software may be stored in a computer-readable medium.

In addition, at least part of the system and method for estimating the location of the forest fire according to the embodiments may be implemented as hardware capable of being electrically connected to the computing device 50.

According to the embodiments of the present disclosure described above, when a fire is detected, the location of the fire is estimated and provided to the user along with the forest fire notification, so that the user may quickly and accurately identify the location of the forest fire.

Although the embodiment of the present disclosure has been described in detail above, the scope of the present disclosure is not limited thereto, and various modifications and improvement forms of those skilled in the art using the basic concept of the present disclosure as defined in the following claims are also within the scope of the present disclosure.

What is claimed is:

1. A system for estimating a location of a forest fire, the system comprising:
an artificial intelligence-based forest fire detection module that detects a forest fire from a captured image using an artificial intelligence model;
a monitoring camera configured to monitor a predetermined area;
a direction estimation module configured to estimate a direction of the forest fire on a map, using a forest fire detection image provided from the artificial intelligence-based forest fire detection module and data of the monitoring camera; and
a location estimation module configured to estimate the location of the forest fire, using an altitude map table configured to provide altitude of a corresponding location from latitude and longitude of the monitoring camera, based on the estimated direction of the forest fire.

2. The system of claim 1, wherein:
the direction estimation module is configured to output the direction of the forest fire on the map using a horizontal angle and a vertical angle.

3. The system of claim 2, wherein:
the location estimation module is configured to specify the direction of the forest fire using the horizontal angle obtained through the direction estimation module.

4. The system of claim 3, wherein:
the location estimation module is configured to specify the direction of the forest fire by defining a straight line between the monitoring camera and a ground using the vertical angle obtained through the direction estimation module, and finding a point where the defined straight line crosses the altitude.

5. The system of claim 1, wherein:
the forest fire detection image includes an image generation time, an image resolution value, and pixel information where the forest fire is located.

6. The system of claim 5, wherein:
the data of the monitoring camera includes information about a camera field of view (FoV), a camera position including a latitude and a longitude, and a camera pan-tilt-zoom (PTZ).

7. The system of claim 6, wherein:
the direction estimation module is configured to estimate the direction of the forest fire on the map based on the pixel information and the information about the camera FoV and the camera PTZ.

8. The system of claim 1, wherein:
when the data of the monitoring camera is provided at a first time and a second time, and the forest fire detection image is provided between the first time and the second time,
the direction estimation module is configured to
estimate the direction of the forest fire on the map based on the data at the first time if the data at the first time is the same as the data at the second time, and,
estimate the direction of the forest fire on the map based on the data at the first time if the data at the first time is different from the data at the second time, and if values of a pan and a FoV of the second time are included in values of a pan and a FoV at the first time.

9. A method of estimating a location of a forest fire, the method comprising:
detecting the forest fire from a captured image using an artificial intelligence model;
monitoring a predetermined area, using a monitoring camera;
estimating a direction of the forest fire on a map, using a detected forest fire detection image and data of the monitoring camera; and
estimating the location of the forest fire, using an altitude map table configured to provide altitude of a corresponding location from latitude and longitude of the monitoring camera, based on the estimated direction of the forest fire.

10. The method of claim 9, wherein:
the estimating of the direction of the forest fire includes outputting the direction of the forest fire on the map using a horizontal angle and a vertical angle.

11. The method of claim 10, wherein:
the estimating of the direction of the forest fire includes specifying the direction of the forest fire using the horizontal angle.

12. The method of claim 11, wherein:
the estimating of the direction of the forest fire includes estimating the direction of the forest fire by defining a straight line between the monitoring camera and a ground using the vertical angle, and finding a point where the defined straight line crosses the altitude.

13. The method of claim 9, wherein:
the forest fire detection image includes an image generation time, an image resolution value, and pixel information where the forest fire is located.

14. The method of claim 13, wherein:
the data of the monitoring camera includes information about a camera field of view (FoV), a camera position including a latitude and a longitude, and a camera pan-tilt-zoom (PTZ).

15. The method of claim 14, wherein:
the estimating of the direction of the forest fire on the map includes estimating the direction of the forest fire on the map based on the pixel information and the information about the camera FoV and the camera PTZ.

16. The method of claim 9, wherein:
when the data of the monitoring camera is provided at a first time and a second time, and the forest fire detection images are provided between the first time and the second time,
the estimating of the direction of the forest fire on the map includes
estimating the direction of the forest fire on the map based on the data at the first time if the data at the first time is the same as the data at the second time, and
estimating the direction of the forest fire on the map based on the data at the first time if the data at the first time is different from the data at the second time, and if values of a pan and a FoV of the second time are included in values of a pan and a FoV at the first time.
